(19) United States
(12) Patent Application Publication
(10) Pub. No.: US 2008/0155539 A1
(43) Pub. Date: Jun. 26, 2008

(54) Automated Data Processing Reconstruction System And Method

(76) Inventors: Edward J. Darland, San Jose, CA (US); Hong Chen, Saratoga, CA (US); Maithilee L. Samant, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/613,940

(22) Filed: Dec. 20, 2006

(51) Int. Cl. G06F 9/46

(52) U.S. Cl. 718/100

(57) ABSTRACT

A data processing system performs a procedure including respective tasks, each respective task including one of producing and processing a respective data object. The system comprises memory; and a processor having program instructions for maintaining a respective data structure for each respective one of the tasks. The data structure includes instructions and parameters for performing the respective task. The processor also has program instructions for determining whether to save the respective data object in memory or to purge the respective data object based on usage and capacity of the memory; and, where the respective data object has been purged and is now needed again, reconstructing the purged data object using the respective data structure.

### BACKGROUND OF THE INVENTION

Many types of data processing equipment, such as mass spectrometers, analytical instrumentation, equipment used in the Life Sciences field, or other test and measurement instruments, acquire large amounts of raw data as they operate. The raw data is then processed by data analysis software. The software allows a user to produce meaningful results from the acquired data, for instance by applying various types of qualitative or quantitative algorithms.

Such processing often takes the form of a procedure having multiple processing tasks. The details of data processing tasks are often as important as the end results. Some research labs or like institutions, such as drug discovery labs, often want to reproduce results of the processing, by applying the same procedure (including the same processing tasks) later on. Other such institutions are required to document all the procedures and their processing tasks in detail, along with the results, especially the labs which could be audited for regulatory compliance by authorities like the FDA.

Currently available data processing systems do not have the ability to automatically reconstruct processing results simply, efficiently, and precisely. They either save each version of the result so that it can be retrieved later, or simply keep a log of processing tasks in the chronological order in which they were performed. When each version of the result is saved, it takes a lot of memory storage space, which can affect performance. When only a log of instructions for the procedures and their tasks is stored, the result has to be manually recreated by following the instructions in the log. Such a manual process is very tedious, error-prone and time-consuming.

### SUMMARY OF THE INVENTION

A data processing system performs a procedure including respective tasks, each respective task including one of producing and processing a respective data object. The system comprises memory; and a processor having program instructions for maintaining a respective data structure for each respective one of the tasks. The data structure includes instructions and parameters for performing the respective task. The processor also has program instructions for determining whether to save the respective data object in memory or to purge the respective data object based on usage and capacity of the memory; and, where the respective data object has been purged and is now needed again, reconstructing the purged data object using the respective data structure.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram of a data structure for a processing task in an embodiment of the invention.

FIG. 2 is a block diagram of a data architecture for a procedure, shown as a data tree made up of a plurality of the data structures of FIG. 1.

FIG. 3 is a flowchart of a reconstruction algorithm.

FIG. 4 is a block diagram of a data entity including the data structure of FIG. 1.

FIG. 5 is a flowchart showing memory management/management purging, including the commencement and cessation of purging.

FIG. 6 is a two-part graph illustrating operation of memory management purging.

FIG. 7 is an illustration of a prior art text log for a procedure.

FIG. 8 is an illustration of a graphical display of a hierarchical log for the data architecture of FIG. 2.

FIG. 9 is an illustration of a table representation of the hierarchical log of FIG. 7.

### DETAILED DESCRIPTION

For purposes of the discussion which follows, let us say that a data processing system embodying the invention performs a procedure involving a number of tasks, each task involving a set of parameters. The procedure might, for instance, begin with a set of raw data, and perform the procedure to producing an ascertainable result, that is, a final set of data. In an embodiment of the invention, a data architecture is employed in which each task corresponds with a data structure.

Such a procedure is to be reproduced, employing the same tasks with the same parameters, such that the ascertainable result can be repeatedly achieved. The term “data object” will be used, broadly to refer to the data which is processed by the procedure. From the context of the discussion which follows, it will be understood that “data object” might refer either to the raw data, data at an intermediate stage of processing, or the final ascertainable result.

A final data object (herein also referred to as an “ascertainable result”) is a result of a procedure made up of one or many processing tasks. To accurately reconstruct the final data object, the details of each processing task are recorded. A processing reconstruction algorithm in an embodiment of the invention defines a data architecture to record details of processing. The data architecture includes a data structure to record the details of each processing task.

For a data analysis software system embodying the invention that is used for processing any analytical measurement data, the intermediate and/or final results of the procedure are expressed as instances of data objects. For instance, consider a mass spectrometer data analysis system. Mass spectrometry is an analytical technique used to measure the mass to charge ratio (m/z) of ions. A mass spectrometer is a device used for mass spectrometry, and produces a mass spectrum of a sample to find its composition. This is normally achieved by ionizing the sample and separating ions of differing masses and recording their relative abundance by measuring intensities of ion flux. A typical mass spectrometer comprises three parts: an ion source, a mass analyzer, and a detector. For such a system embodying the invention, one data object might represent a mass spectrum, and another might represent a chromatogram. An example of such an ascertainable result is a spectrum, generated by a mass spectrometer running a measurement procedure. Such a mass spectrometer data analysis system (for instance, including a workstation) might start with raw spectrum data which was acquired by a mass spectrometer system, process the spectrum data by means of a sequence of tasks, and produce, as the ascertainable result, spectrum data that has been suitably processed.

### Data Structure, Data Architecture (e.g., Tree)

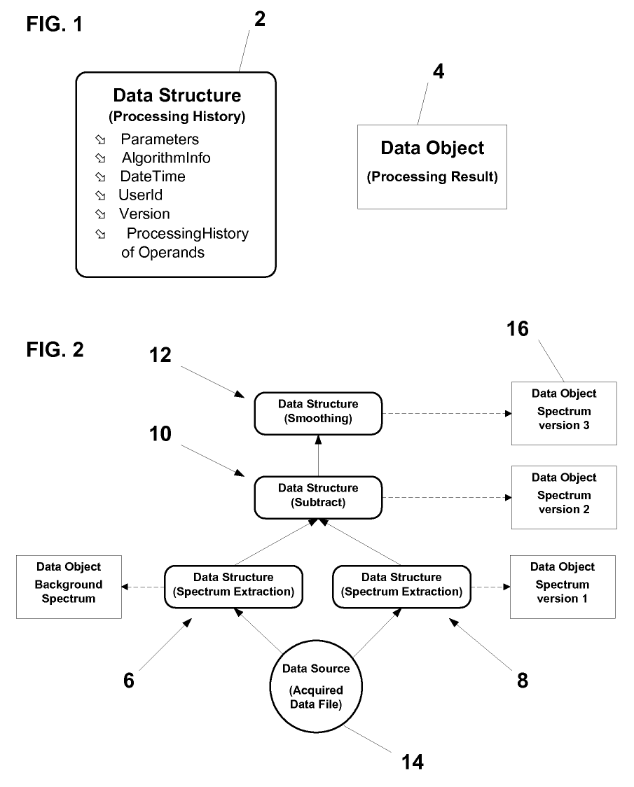

FIG. 1 is a block diagram representation of such a data structure 2. In the illustrated example, the data structure is designated by the name “ProcessingHistory” which, for the discussion which follows, will be used synonymously with “data structure”. Processing History comprises metadata that records all the parameters, including the type of algorithm used, timestamp, userID and version. It also holds references to ProcessingHistory of all the operands (such as data objects) that resulted from previous processing tasks of the procedure. The operands are the previously derived results, if any, that the algorithm uses to create the new processing result. The result of the processing task is a data object 4, also shown.

For a procedure containing multiple tasks, the data architecture will include one such data structure 2, i.e., one instance of ProcessingHistory, for each task of the procedure. In many cases, the procedure involves a succession of tasks, each successive task employing the data object resulting from the immediately previous task. For instance, if an initial raw data object is processed by a procedure comprising three tasks performed in series, then reconstructing the data object produced by the third task may require starting with the initial raw data object, reconstructing the data object of the first task, and then reconstructing the data object of the second task, which is then used as the starting point for reconstructing the data object of the third task. Thus, performing a reconstruction may involve recursively performing one or more predecessor reconstructions, and a ProcessingHistory for the third task may include, or include calls to, the ProcessingHistories for the previous two tasks.

FIG. 2 is a block diagram representation of such data structures, which together express a data architecture that represents the procedure comprising multiple tasks. The data architecture may be thought of as comprising multiple nodes 6, 8, 10, and 12, each node having a data structure, e.g., a ProcessingHistory metadata, as per FIG. 1. As shown in the block diagram of FIG. 2, the data structures are linked, so as to represent the relationships and order between different tasks of the procedure.

A procedure generally starts with raw data acquired from an initial data source, i.e., an initial data object 14, and takes multiple processing tasks to reach a final resultant data object 16. The complete processing history for an analysis procedure is represented by an architecture, such as a tree, of many ProcessingHistory nodes, represented by the data structures of FIGS. 1 and 2. If a procedure involves multiple processing tasks, then the tree of ProcessingHistory nodes has branches to record earlier processing of each operand for each processing task. It will be understood that, while FIG. 2 shows two “child nodes” 6 and 8 whose data objects are used by the data structure 10 to generate the data object “Spectrum version 2), there can be any number of such child nodes, etc., for any given task of a procedure.

Here is an example of how a particular mass spectrometry procedure corresponds with the architecture of FIG. 2. A user can start by extracting raw data (14) of a spectrum (version 1) for certain mass range from the data file; select a noise region to extract a background spectrum; do background spectrum subtraction to get spectrum version 2; then apply a smoothing algorithm on the spectrum. This smoothed spectrum can be considered as version 3 (16) and the final result for the user in this case. In an embodiment of the invention, such spectrum data objects may or may not be retained in memory. If a data object has been purged from memory and is later needed again, it is reconstructed as per the discussion which follows:

### Reconstruction Algorithm

In an embodiment of the invention, there is provided a processing reconstruction algorithm. This algorithm allows software manually or automatically to reconstruct any version of the result, which eliminates the need to save each version of the result.

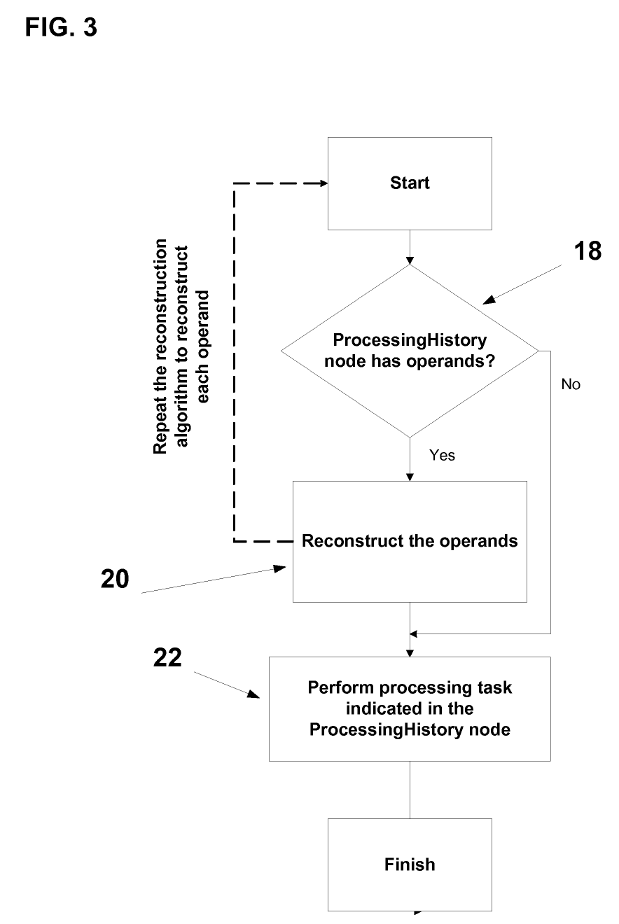

FIG. 3 is a flowchart showing the reconstruction algorithm in an embodiment of the invention. The algorithm traverses the ProcessingHistory tree (e.g., that of FIG. 2) by visiting one node at a time. For each node the reconstruction algorithm reads the metadata parameters (18) from the ProcessingHistory data structure, determines whether the processing task requires operands that may themselves need to be reconstructed, and calls the appropriate algorithm with those parameters. The reconstruction algorithm traverses the tree and constructs all operands (20) by visiting child nodes of the current ProcessingHistory node. (The term “child node” refers to a node representing a task that precedes the current task in the procedure. Where a child node produces an operand, such as a data object, that is required for the current processing task, this algorithm is called recursively, to reconstruct that operand.) Once all operands are constructed, the reconstruction algorithm performs the processing task (22) indicated in the current ProcessingHistory node.

An example of a pseudo code implementation for such a reconstruction algorithm is as follows:

```
Function DataObject ReconstructData(ProcessingHistory
processingHistory)
{
  if (ProcessingHistory == null)
  {
    // This is terminating condition of recursive algorithm so return
    return null;
  }
  //Use post order algorithm to traverse ProcessingHistory tree
  DataObject [ ] operands = new DataObject[ProcessingHistory.
  ChildrenCount];
  for( int childId = 0;
    childId < ProcessingHistory.ChildrenCount;
    childId++)
  {
    Operands[childId] =
    ReconstructData(ProcessingHistory.Child[childId]);
  }
  ProcessingAlgorithm = ProcessingHistory.Algorithm;
  return ProcessingAlgorithm.CreateResultObject(
          operands, ProcessingHistory.Parameters);
}
```

Any data analysis software with an algorithm such as this algorithm is not required to save all versions of the result to be able to reconstruct them in the future.

### Memory Management—Management Purging and Reconstruction

One of the challenges that data analysis software for measurement instruments has is the ability to deal with large amounts of data. It affects not only the performance, but also the ability to process all the data with limited physical memory. Traditionally the software either has to impose a limit on the maximum size of the data it can handle, or it can only process a portion of the data at one time.

For instance, if a mass spectrometer generates spectra that may occupy thousands, or even millions, of bytes each, and its companion data analysis software is required to handle thousands of such spectra at a time, the software's memory requirements likely will far exceed the memory available to the system's processor.

In an embodiment of the invention, the software management purges memory occupied by data objects (such as spectra), and the reconstruction algorithm described above regenerates purged spectra as and when needed. Such memory management creates an illusion that all of the spectra are present in the memory even when some of them are not. In addition it allows the user to work with all the data without running out of memory.

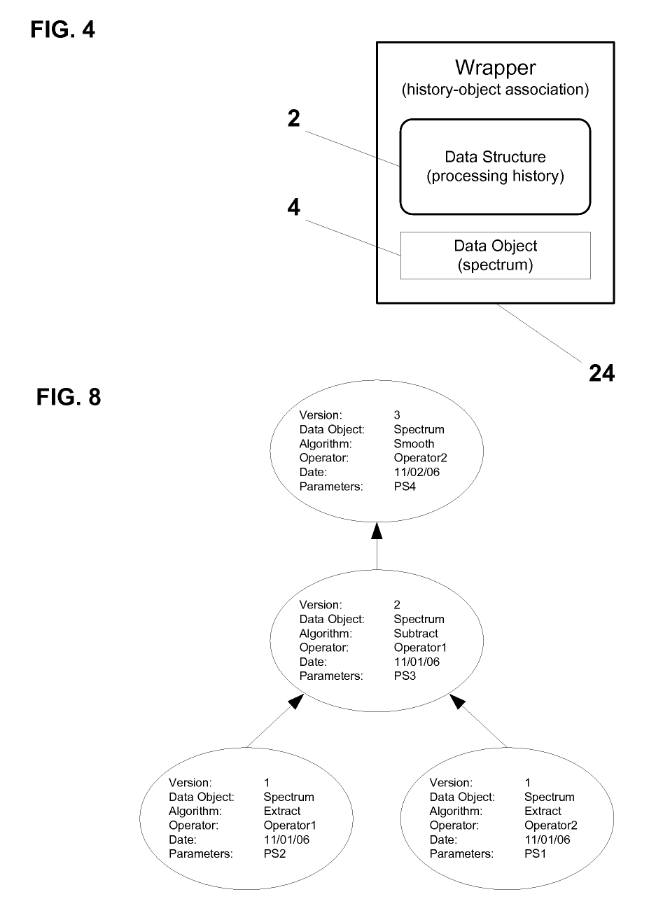

FIG. 4 is an illustration of a data entity that is a superset of the data structure of FIG. 1. A single data structure 2, similar to that of FIG. 1, is shown. Also shown is a representation of the data object 4 produced by the task; for instance, in the illustrated example pertaining to a mass spectrometer, the data object 4 is a spectrum object. Note, however, that the representation of the data object 4 is not necessarily the data object itself. Rather, if the data object has been purged to free up memory, the representation of the data object 4 is a placeholder, not taking up the amount of memory the data object itself would take up.

For the present example, the three classes of data are shown as follows: First, there is the representation of the data object 4 itself (either the actual data object, or the placeholder). The data object contains the actual spectrum data.

Second, there is the data structure ProcessingHistory 2 (such as that of FIG. 1). Every such data object has a corresponding ProcessingHistory, which has all the information needed to reconstruct the data object.

It generally is the case that the data object will take up orders of magnitude more memory capacity than the data structure ProcessingHistory.

Third, there is a class of data 24 that maintains the relationship between a ProcessingHistory 2 and its resultant Data Object 4, here named the “Wrapper”.

The wrapper 24 facilitates the freeing-up, as appropriate, of the memory taken up by the data object 4. The wrapper 24 is a data entity which may be thought of as a proxy, impersonator, or “doppelganger” (defined in the Merriam-Webster dictionary as “a ghostly counterpart of a living person”), of the data object 4. It need not contain the full quantity of data making up the data object 4 itself. However, the wrapper 24 has certain predetermined interface characteristics which, for the purpose of interfacing or interacting with, or handling by, outside software entities, allows the wrapper 24 to substitute for the data object 4. As a consequence, the wrapper 24 externally supports all the functionality that the data object (e.g., a spectrum) 4 supports. The outside software entities, such as other software applications, use the wrapper 24 instead of directly using spectrum data object 4.

The wrapper 24 can reconstruct the data object 4, using the data structure ProcessingHistory 2, when the data object 4 has been purged from memory and is subsequently needed again.

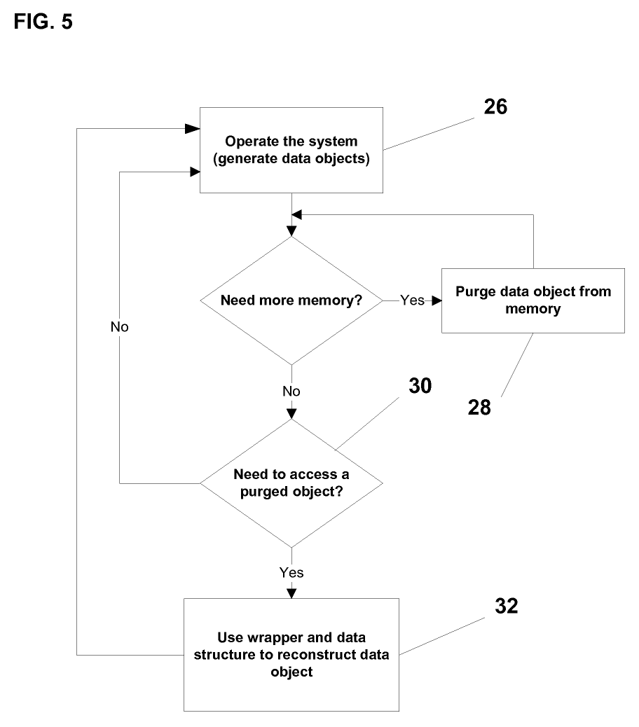

FIG. 5 is a flowchart, illustrating a process for operating a system embodying the invention is shown. In the course of operating the system and generating data objects (26), a data object is purged (28). Then, a decision is made that it is needed back again (30). As described above, the wrapper and data structure are then used to reconstruct the data object (32). Afterward, the system resumes its operation (26).

In operating such a system, various criteria will be relevant to the question when to purge a data object, and when to restore it. Such criteria include but are not limited to the size of the data objects, the memory capacity of the system, the operating speed and throughput of the system, and the length of time needed to reconstruct a data object. One example of such criteria is defining available memory threshold(s) which when reached purging is either turned on or off. Another example of criteria used to purge objects is based on usage of the objects, so the system might decide to purge objects the user has not recently worked with or the objects which the system predicts will not be used by user for future period of time.

Memory management in a reconstruction algorithm can involve thousands of wrapper instances. Though the user of the application is working with multiple data objects (e.g., spectra) 4 simultaneously, the application internally accesses one spectrum 4 at a time. Whenever the internal spectrum data object 4 is accessed, the wrapper ensures that it is referring to a spectrum data object 4 that is available, either because it exists in memory, or because it can be reconstructed as needed. It may typically take only a fraction of a second to reconstruct a data object (e.g., spectrum), but this consumption of time is still a performance penalty, particularly when a large number of spectra are to be analyzed. When enough memory is available to fit all objects, such performance penalties are kept to a minimum by not purging any data objects.

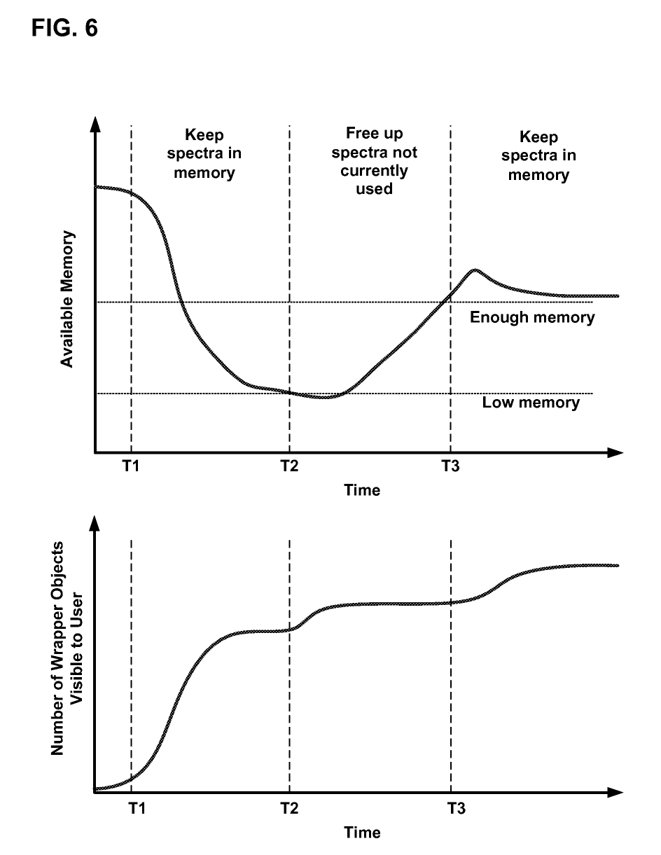

FIG. 6 is a two-part graph illustrating a procedure in which various spectra are kept in memory, then some of the spectra are purged to free up system memory, and then the spectra are reconstructed according to the reconstruction algorithm of an embodiment of the invention. The algorithm of this embodiment employs two threshold levels of memory, shown as “enough memory” and “low memory”. The graph shows, as a function of time, memory utilization during the course of a mass spectrometry procedure.

At start-up time (T1), there is enough memory available, and existing spectra are kept in memory. As time passes more and more spectrum data is generated and held in memory, so available memory (the upper graph) starts going down. Likewise, the number of wrappers (data objects) increases, as shown in the lower graph.

Eventually, the available memory reaches the “Low Memory” threshold at time T2. Data objects are then selected based on appropriate criteria, such as lack of recent use, and are purged from memory to free up memory that had been holding them. For each data object that is purged, an impersonator (such as that of FIG. 4) is created. As data objects are purged, the amount of available memory (upper graph) goes up. However, the number of wrapper objects (either actual data objects or impersonators) shown in the lower graph remain even, or continue to grow.

In between times T2 and T3, this purging frees up memory. As memory is freed, available memory goes up. At the time T3, available memory has reached the “enough memory” threshold. Thereafter, newly created spectrum data objects are again kept in the memory, and the number of wrapper objects (real data objects or impersonators) in the lower graph continues to grow. Any spectrum data object that later is requested or needed by the user, but was purged to free the memory, will be recreated using the data reconstruction algorithm.

In an embodiment of the invention, the reconstruction algorithm and the data structure ProcessingHistory makes it possible for the system to manage memory efficiently. From the user's perspective, the system behaves as though there is sufficient memory available to fit as many large data objects as are necessary for the procedure being performed, even though at some times some of the data objects will have been purged.

### Hierarchical Logbook

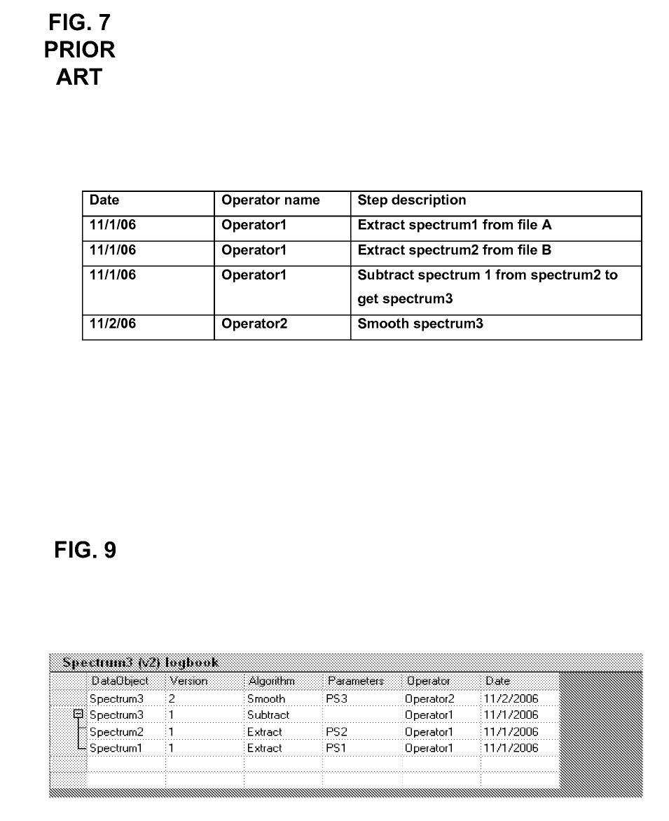

Conventionally, most of the data systems save data processing steps in chronological order, in an “electronic logbook”. Such a logbook is typically formatted as a data structure such as a table (FIG. 7) having with one row per processing task. However, many common data processing tasks cannot be effectively represented in a single logbook row. This makes reading and analyzing the logbook a complex task.

In addition, the conventional logbook tends to capture the summary of the operation instead of capturing all the details of the operation. For instance, the logbook may note that a “smoothing” algorithm was applied on the data object. However, this logbook entry but typically does not contain all the parameters that were given to the “smoothing” algorithm. This makes recreating the exact same results using the information in the logbook difficult or even impossible.

A hierarchical logbook, as per an embodiment of the invention, includes user-manipulable graphical interface functionality. As such, it provides a reliable and complete hierarchical structure for capturing all the details and order of processing steps. With such a hierarchical logbook, users can easily browse through the flow of a complex series of processing steps. The hierarchical logbook captures all the parameters and algorithm details used for each processing step, as well as the order of the steps. The completeness of the information allows implementing a feature where users can reconstruct any version of the data object by a simple mouse click on a node of a hierarchical logbook.

To illustrate such a Hierarchical logbook, consider the following example. Suppose the following steps were taken to process a data object (spectrum in this case) to produce a final ascertainable result designated “spectrum3”:
1. Extract spectrum1 from file A with parameter set PS1
2. Extract spectrum2 from file B with parameter set PS2
3. Subtract spectrum 1 from spectrum2 to get spectrum3
4. Smooth spectrum3 with parameter set PS3

A conventional logbook will represent the above steps in a simple textual table, such as that shown in FIG. 7. Such a conventional logbook has a set of columns, which typically include date and time, operator id, textual representation of the processing step, etc. Generally, each row (representing a respective processing task) is given in terms of textual information, and the rows are ordered chronologically. Operands are generally referred to by textual descriptions which may not uniquely identify the data object in systems where hundreds or thousands of data objects are in use. To use such a conventional log, the user must read the row entries, one by one, and perform the respective processing tasks, at least in part by hand data entry and operation of the system.

A hierarchical logbook in an embodiment of the invention represents the same information graphically, for instance as shown in FIG. 8.

In an embodiment of the invention, the user is provided with a graphical representation of the various data structures, etc, making up the representation of the procedure. For instance, the representation can be a graphical representation of the tree structure of FIG. 2 or 8, on a computer workstation screen, etc. In embodiments for which the data objects and data structures are separately shown, the data objects may be shown with indicia of whether the data object is actually present in memory, or has been purged. For instance, purged data objects can be shown in lighter colors, dotted-line images, different color or shading, etc. Also, it can be user-selectable whether the purged data objects are shown with such different indicia, or whether data objects are shown the same way, whether they are present in memory or purged.

Graphical user interface capabilities such as command input may then be provided to the user. For instance, in an embodiment of the invention a user may be able to able reconstruct any version of the data object by a simple mouse click on the graphical image (or table row) of a data structure representing a processing task to be run.

A conventional logbook's tabular structure can not capture binary (or n-ary) processing steps effectively (e.g. addition or subtraction of two objects to create a resultant object). On the other hand hierarchical logbooks have the ability to capture processing steps with multiple operands and parameters easily.

Hierarchical logbooks can be used by the software to retrieve parameters and operands for any processing step. This allows software automatically and precisely to re-execute the same processing step or series of processing steps.

A hierarchical logbook which is associated with a data object can be applied to retrieve a similar data object from a different data source.

In addition, it also allows the option to generate the conventional text-formatted logbook, such as that of FIG. 7. As an alternative to the tree structure of FIG. 8, a hierarchical logbook functionally equivalent to that shown in FIG. 8 may be displayed as a table (FIG. 9). Unlike the conventional table of FIG. 7 that merely gives text, the table of FIG. 9 includes the graphical user interface functionality just described for the tree structures of FIG. 8.

Graphical user interface capability is provided for a hierarchical representation of logbooks, such the hybrid tabular representation of FIG. 9. Using any hierarchical representation of a logbook, a user input, such as a right click, on any task of interest generates a pop-up menu, including user options such as the following:
Reconstruct this data object—This menu will reconstruct the selected data object by using a data processing reconstruction algorithm.
Construct like this from different file—This menu will use the data processing reconstruction algorithm to follow the processing steps specified in the data structure, but create a data object from a user-specified different source data file.
Show parameter details—This menu will bring up a dialog box to display parameters the selected task is to use, or has used.
Copy parameters—This menu will copy the parameters used in the selected task for re-use, storage, printing, later use with a different task, etc. For instance, the parameters may be copied to a software clipboard, and then pasted into another task, a storage or printing tool, etc.
Show as table—This menu will create a traditional tabular display (e.g., FIG. 7) for the user.
Show as tree—This menu will create a graphical display in the form of a tree (e.g., FIG. 8). Note that additional user options can provide other desired display formats. Alternatively, a single “show as” command can call up a menu of possible display formats, for instance including a tree (FIG. 8), a text table (FIG. 7), a table with graphical functionality (FIG. 9), etc. The user can then select the desired display format with an additional mouse click.

The system is user-friendly, with little visual clutter and logically-structured operation flow. Each node has detailed information regarding the respective processing task, including all the parameters for the algorithm. The relationship between various tasks is provided graphically. Tasks with branches can be collapsed/expanded as the user navigates through the tasks of the procedure. Sorting and filtering on one or multiple columns is facilitated.

The invention may be embodied in various types of data processing systems, including without limitation mass spectrometer data analysis systems. The invention may also be embodied in a data processing reconstruction method performed by such systems, or in a computer program product (for instance, a computer-readable medium such as a CD-ROM, etc., bearing computer program instructions for directing a processor to perform such reconstruction.

Aspects of the invention for which patent claim coverage is sought are set forth in the “CLAIMS” section below. However, additional patentable aspects of the invention potentially may include the following:

A. A mass spectrometer data analysis system for performing a procedure including respective tasks, each respective task including one of producing and processing a respective data object, the system comprising:

memory; and

a processor having program instructions for performing:

(i) maintaining a respective data structure for each respective one of the tasks, the data structure including instructions and parameters for performing the respective task;

(ii) determining whether to save the respective data object in memory or to purge the respective data object based on usage and capacity of the memory; and

(iii) where the respective data object has been purged and is now needed again, reconstructing the purged data object using the respective data structure.

B. A mass spectrometer data analysis system as recited in A, wherein reconstructing a data object for a given one of the respective tasks includes starting with a data object for a task immediately preceding the given task, and performing the instructions within the respective data structure of the given task.

C. A mass spectrometer data analysis system as recited in A, wherein the processor further has program instructions for maintaining, for each of the respective tasks, a data entity that comprises (a) the respective data structure, and (b) either (i) the data object, or (ii) a representation of the data object.

D. A mass spectrometer data analysis system as recited in C, wherein the representation of the data object has a characteristic in common with a corresponding characteristic of the data object itself.

E. A mass spectrometer data analysis system as recited in A:

further comprising a graphical user interface, and

wherein the processor further has instructions:

(i) for displaying a representation of the tasks of the procedure and

(ii) for performing the reconstructing based on user input to the graphical user interface, the user input being related to the displayed representation of the respective task.

F. A mass spectrometer data analysis system as recited in E, wherein each of the displayed representations of the respective tasks of the procedure include (i) a representation of the respective data structure, and (ii) a representation of the data object, including indicia of whether the data object is in memory or has been purged.

G. A mass spectrometer data analysis system as recited in E, wherein the displayed representation of the respective task includes a hierarchical log.

H. A mass spectrometer data analysis system as recited in G, wherein:

the processor has further instructions for developing and maintaining a hierarchical log having respective nodes corresponding with the respective tasks; and

the graphical user interface employs the hierarchical log for viewing parameters and selecting functions pertaining to the respective nodes.

I. A mass spectrometer data analysis system as recited in A, wherein the processor has further instructions for performing a memory management purge.

J. A mass spectrometer data analysis system as recited in I, wherein the memory management purge includes:

purging data objects when the available memory is beneath a first threshold, to increase the available memory; and

keeping newly created data objects after the purging has increased the available memory above a second threshold.

K. A mass spectrometer data analysis system as recited in J, wherein the purging includes selecting data objects for purging based on the amount of recent use of the data objects.

L. An automated mass spectrometer data analysis reconstruction method, for use with a data processing system for performing a procedure including respective tasks, each respective task including one of producing and processing a respective data object, the method comprising:

(i) maintaining a respective data structure for each respective one of the tasks, the data structure including instructions and parameters for performing the respective task;

(ii) determining whether to save the respective data object in memory or to purge the respective data object based on usage and capacity of the memory; and

(iii) where the respective data object has been purged and is now needed again, reconstructing the purged data object using the respective data structure.

M. An automated mass spectrometer data analysis reconstruction method as recited in L, wherein reconstructing a data object for a given one of the respective tasks includes starting with a data object for a task immediately preceding the given task, and performing the instructions within the respective data structure of the given task.

N. An automated mass spectrometer data analysis reconstruction method as recited in L, further comprising maintaining, for each of the respective tasks, a data entity that comprises (a) the respective data structure, and (b) either (i) the data object, or (ii) a representation of the data object.

O. An automated mass spectrometer data analysis reconstruction method as recited in N, wherein the representation of the data object has a characteristic in common with a corresponding characteristic of the data object itself.

P. An automated mass spectrometer data analysis reconstruction method as recited in L, further comprising

(i) displaying a representation of the tasks of the procedure on a graphical user interface, and

(ii) performing the reconstructing based on user input to the graphical user interface, the user input being related to the displayed representation of the respective task.

Q. An automated mass spectrometer data analysis reconstruction method as recited in P, wherein each of the displayed representations of the respective tasks of the procedure include (i) a representation of the respective data structure, and (ii) a representation of the data object, including indicia of whether the data object is in memory or has been purged.

R. An automated mass spectrometer data analysis reconstruction system as recited in P, wherein the displayed representation of the respective task includes a hierarchical log.

S. An automated mass spectrometer data analysis reconstruction method as recited in R, further comprising:

developing and maintaining a hierarchical log having respective nodes corresponding with the respective tasks; and wherein;

the graphical user interface employs the hierarchical log for viewing parameters and selecting functions pertaining to the respective nodes.

T. An automated mass spectrometer data analysis reconstruction method as recited in L, further comprising performing a memory management purge.

U. An automated mass spectrometer data analysis reconstruction method as recited in T, wherein the memory management purge includes:

purging data objects when the available memory is beneath a first threshold, to increase the available memory; and

keeping newly created data objects after the purging has increased the available memory above a second threshold.

V. A computer program product, for providing program instructions to a data processing system that includes a mass spectrometer data analysis system for performing a procedure including respective tasks, each respective task including one of producing and processing a respective data object, the computer program product comprising:

a computer-readable medium, and
program instructions, provided on the computer-readable medium, for instructing the data processing system to:

(i) maintain a respective data structure for each respective one of the tasks, the data structure including instructions and parameters for performing the respective task;

(ii) determine whether to save the respective data object in memory or to purge the respective data object based on usage and capacity of the memory; and

(iii) where the respective data object has been purged and is now needed again, reconstruct the purged data object using the respective data structure.

W. A computer program product as recited in V, wherein reconstructing a data object for a given one of the respective tasks includes starting with a data object for a task immediately preceding the given task, and performing the instructions within the respective data structure of the given task.

X. A computer program product as recited in V, further comprising program instructions, provided on the computer-readable medium, for instructing the data processing system to maintain, for each of the respective tasks, a data entity that comprises (a) the respective data structure, and (b) either (i) the data object, or (ii) a representation of the data object.

Y. A computer program product as recited in X, wherein the representation of the data object has a characteristic in common with a corresponding characteristic of the data object itself.

Z. A computer program product as recited in V, further comprising program instructions, provided on the computer-readable medium, for instructing the data processing system to

(i) display a representation of the tasks of the procedure on a graphical user interface, and

(ii) perform the reconstructing based on user input to the graphical user interface, the user input being related to the displayed representation of the respective task.

AA. A computer program product as recited in V, wherein each of the displayed representations of the respective tasks of the procedure include (i) a representation of the respective data structure, and (ii) a representation of the data object, including indicia of whether the data object is in memory or has been purged.

BB. A computer program product as recited in Z, wherein the displayed representation of the respective task includes a hierarchical log.

CC. A computer program product as recited in BB, further comprising program instructions, provided on the computer-readable medium, for instructing the data processing system to:

develop and maintain a hierarchical log having respective nodes corresponding with the respective tasks; and wherein;

the graphical user interface employs the hierarchical log for viewing parameters and selecting functions pertaining to the respective nodes.

DD. A computer program product as recited in V, further comprising program instructions, provided on the computer-readable medium, for instructing the data processing system to perform a memory management purge.

EE. A computer program product as recited in claim DD, wherein the memory management purge includes:

purging data objects when the available memory is beneath a first threshold, to increase the available memory; and

keeping newly created data objects after the purging has increased the available memory above a second threshold.

FF. A computer program product as recited in claim EE, wherein the purging includes selecting data objects for purging based on the amount of recent use of the data objects.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A data processing system for performing a procedure including respective tasks, each respective task including one of producing and processing a respective data object, the system comprising:
memory; and
a processor having program instructions for performing:
(i) maintaining a respective data structure for each respective one of the tasks, the data structure including instructions and parameters for performing the respective task;
(ii) determining whether to save the respective data object in memory or to purge the respective data object based on usage and capacity of the memory; and
(iii) where the respective data object has been purged and is now needed again, reconstructing the purged data object using the respective data structure.

2. A data processing system as recited in claim 1, wherein reconstructing a data object for a given one of the respective tasks includes starting with a data object for a task immediately preceding the given task, and performing the instructions within the respective data structure of the given task.

3. A data processing system as recited in claim 1, wherein the processor further has program instructions for maintaining, for each of the respective tasks, a data entity that comprises (a) the respective data structure, and (b) either (i) the data object, or (ii) a representation of the data object.

4. A data processing system as recited in claim 3, wherein the representation of the data object has a characteristic in common with a corresponding characteristic of the data object itself.

5. A data processing system as recited in claim 1:
further comprising a graphical user interface, and
wherein the processor further has instructions:
(i) for displaying a representation of the tasks of the procedure and
(ii) for performing the reconstructing based on user input to the graphical user interface, the user input being related to the displayed representation of the respective task.

6. A data processing system as recited in claim 5, wherein each of the displayed representations of the respective tasks of the procedure include (i) a representation of the respective data structure, and (ii) a representation of the data object, including indicia of whether the data object is in memory or has been purged.

7. A data processing system as recited in claim 5, wherein the displayed representation of the respective task includes a hierarchical log.

8. A data processing system as recited in claim 7, wherein:
the processor has further instructions for developing and maintaining a hierarchical log having respective nodes corresponding with the respective tasks; and
the graphical user interface employs the hierarchical log for viewing parameters and selecting functions pertaining to the respective nodes.

9. A data processing system as recited in claim 1, wherein the processor has further instructions for performing a memory management purge.

10. A data processing system as recited in claim 9, wherein the memory management purge includes:
purging data objects when the available memory is beneath a first threshold, to increase the available memory; and
keeping newly created data objects after the purging has increased the available memory above a second threshold.

11. A data processing system as recited in claim 10, wherein the purging includes selecting data objects for purging based on the amount of recent use of the data objects.

12. A data processing system as recited in claim 1, wherein the data processing system includes a mass spectrometer data analysis system.

13. An automated data processing reconstruction method, for use with a data processing system for performing a procedure including respective tasks, each respective task including one of producing and processing a respective data object, the method comprising:
(i) maintaining a respective data structure for each respective one of the tasks, the data structure including instructions and parameters for performing the respective task;
(ii) determining whether to save the respective data object in memory or to purge the respective data object based on usage and capacity of the memory; and
(iii) where the respective data object has been purged and is now needed again, reconstructing the purged data object using the respective data structure.

14. An automated data processing reconstruction method as recited in claim 13, wherein reconstructing a data object for a given one of the respective tasks includes starting with a data object for a task immediately preceding the given task, and performing the instructions within the respective data structure of the given task.

15. An automated data processing reconstruction method as recited in claim 13, further comprising maintaining, for each of the respective tasks, a data entity that comprises (a) the respective data structure, and (b) either (i) the data object, or (ii) a representation of the data object.

16. An automated data processing reconstruction method as recited in claim 15, wherein the representation of the data object has a characteristic in common with a corresponding characteristic of the data object itself.

17. An automated data processing reconstruction method as recited in claim 13, further comprising
(i) displaying a representation of the tasks of the procedure on a graphical user interface, and
(ii) performing the reconstructing based on user input to the graphical user interface, the user input being related to the displayed representation of the respective task.

18. An automated data processing reconstruction method as recited in claim 17, wherein each of the displayed representations of the respective tasks of the procedure include (i) a representation of the respective data structure, and (ii) a representation of the data object, including indicia of whether the data object is in memory or has been purged.

19. An automated data processing reconstruction system as recited in claim 17, wherein the displayed representation of the respective task includes a hierarchical log.

20. An automated data processing reconstruction method as recited in claim 19, further comprising:
developing and maintaining a hierarchical log having respective nodes corresponding with the respective tasks; and wherein;
the graphical user interface employs the hierarchical log for viewing parameters and selecting functions pertaining to the respective nodes.

21. An automated data processing reconstruction method as recited in claim 13, further comprising performing a memory management purge.

22. An automated data processing reconstruction method as recited in claim 21, wherein the memory management purge includes:
purging data objects when the available memory is beneath a first threshold, to increase the available memory; and
keeping newly created data objects after the purging has increased the available memory above a second threshold.

23. An automated data processing reconstruction method as recited in claim 22, wherein the purging includes selecting data objects for purging based on the amount of recent use of the data objects.

24. An automated data processing reconstruction method as recited in claim 13, wherein the method is performed on a data processing system that includes a mass spectrometer data analysis system.

25. A computer program product, for providing program instructions to a data processing system for performing a procedure including respective tasks, each respective task including one of producing and processing a respective data object, the computer program product comprising:
a computer-readable medium, and
program instructions, provided on the computer-readable medium, for instructing the data processing system to:
(i) maintain a respective data structure for each respective one of the tasks, the data structure including instructions and parameters for performing the respective task;
(ii) determine whether to save the respective data object in memory or to purge the respective data object based on usage and capacity of the memory; and
(iii) where the respective data object has been purged and is now needed again, reconstruct the purged data object using the respective data structure.

26. A computer program product as recited in claim 25, wherein reconstructing a data object for a given one of the respective tasks includes starting with a data object for a task immediately preceding the given task, and performing the instructions within the respective data structure of the given task.

27. A computer program product as recited in claim 25, further comprising program instructions, provided on the computer-readable medium, for instructing the data processing system to maintain, for each of the respective tasks, a data entity that comprises (a) the respective data structure, and (b) either (i) the data object, or (ii) a representation of the data object.

28. A computer program product as recited in claim 27, wherein the representation of the data object has a characteristic in common with a corresponding characteristic of the data object itself.

29. A computer program product as recited in claim 25, further comprising program instructions, provided on the computer-readable medium, for instructing the data processing system to
(i) display a representation of the tasks of the procedure on a graphical user interface, and
(ii) perform the reconstructing based on user input to the graphical user interface, the user input being related to the displayed representation of the respective task.

30. A computer program product as recited in claim 25, wherein each of the displayed representations of the respective tasks of the procedure include (i) a representation of the respective data structure, and (ii) a representation of the data object, including indicia of whether the data object is in memory or has been purged.

31. A computer program product as recited in claim 29, wherein the displayed representation of the respective task includes a hierarchical log.

32. A computer program product as recited in claim 31, further comprising program instructions, provided on the computer-readable medium, for instructing the data processing system to:
develop and maintain a hierarchical log having respective nodes corresponding with the respective tasks; and wherein;
the graphical user interface employs the hierarchical log for viewing parameters and selecting functions pertaining to the respective nodes.

33. A computer program product as recited in claim 25, further comprising program instructions, provided on the computer-readable medium, for instructing the data processing system to perform a memory management purge.

34. A computer program product as recited in claim 33, wherein the memory management purge includes:
purging data objects when the available memory is beneath a first threshold, to increase the available memory; and
keeping newly created data objects after the purging has increased the available memory above a second threshold.

35. A computer program product as recited in claim 34, wherein the purging includes selecting data objects for purging based on the amount of recent use of the data objects.

36. A computer program product as recited in claim 25, wherein the program instructions are provided to a data processing system that includes a mass spectrometer data analysis system.
